(19) United States
(12) Patent Application Publication
(10) Pub. No.: US 2009/0285003 A1
(43) Pub. Date: Nov. 19, 2009

(54) BOOST CONVERTER

(76) Inventor: Takuya ISHII, Osaka (JP)

Correspondence Address: MCDERMOTT WILL & EMERY LLP, 600 13TH STREET, NW, WASHINGTON, DC, 20005-3096, US

(21) Appl. No.: 12/338,499

(22) Filed: Dec. 18, 2008

(30) Foreign Application Priority Data
May 15, 2008 (JP) 2008-128823

(51) Int. Cl. H02M 7/217

(52) U.S. Cl. 363/127

(57) ABSTRACT

In a boost converter including an input transistor receiving an input voltage, an inductor and a main switch serially connected to the input transistor, rectifying means connected to a node between the inductor and the main switch and smoothing means for smoothing the output of the rectifying means to generate an output voltage, a current detection circuit generates a current detection signal corresponding to the current flowing through the input transistor. A voltage detection circuit generates a voltage detection signal corresponding to the output voltage. A startup circuit adjusts the current at the input transistor until the output voltage reaches a first voltage when being lower than the first voltage, and turns ON the input transistor when being higher than the first voltage. A control circuit controls ON/OFF of the main switch based on the current and voltage detection signals so that the output voltage becomes a predetermined value.

### CROSS-REFERENCE TO RELATED APPLICATIONS

This application claims priority under 35 U.S.C. §119 on Patent Application No. 2008-128823 filed in Japan on May 15, 2008, the entire contents of which are hereby incorporated by reference.

### BACKGROUND OF THE INVENTION

The present disclosure relates to a boost converter for supplying DC voltage to various types of electronic equipment, and more particularly to a switching boost converter.

In recent years, thanks to its high-efficient power conversion characteristic, a switching boost converter has been used as a power supply circuit for many types of electronic equipment having a battery as an input power supply. A boost converter generally includes: an inductor one terminal of which is connected to an input power supply; and a switch and a diode connected to the other terminal of the inductor. The other terminal (cathode) of the diode to which an output capacitor is connected serves as the output of the converter. Under ON/OFF operation of the switch, energy is stored in and released from the inductor repeatedly, to generate an output voltage higher than the input voltage.

In the boost converter configured of the inductor and the diode serially connected between the input power supply and the output terminal, however, if the output is short-circuited, a short-circuit current will flow from the input power supply through the inductor and the diode even when the switching operation for boosting is stopped, for example. To avoid damage to components due to such a short-circuit current, a boost converter as follows has been invented.

FIG. 9 shows a circuit configuration of a conventional boost converter. During normal operation, an input switch 2a is ON, and a main switch 4 turns ON/OFF according to a pulse signal Vg outputted from a PWM controller 22 in response to the output of an error amplifier 21. With the electromagnetic induction function of an inductor 3 and the rectification function of a diode 5, a stable output voltage Vo higher than an input voltage Vi from an input power supply 1 is generated at an output capacitor 6. If the output is short-circuited, a short-circuit detection circuit 23 is actuated in response to the output of the error amplifier 21, to turn OFF the input switch 2a. As a result, power supply from the input power supply 1 to the boost converter is shut off. In this relation, a circuit time constant is provided to turn OFF the main switch 4 and the input switch 2a after a lapse of a fixed time from detection of the output short circuit. With this configuration, occurrence of an overcurrent is suppressed by turning OFF the input switch 2a at the time of an output short circuit. Also, having the circuit time constant, the short-circuit detection circuit 23 is prevented from malfunctioning at the time of instantaneous output drop at startup and due to an abrupt load change (see Japanese Laid-Open Patent Publication No. 5-304766, for example).

### SUMMARY OF THE INVENTION

The boost converter of FIG. 9 has a problem that once the input switch 2a is turned ON at startup, the current flowing from the input power supply 1 to charge the output capacitor 6 is not limited and this may cause an inrush current. Also, overload protection is generally required for a power supply circuit to protect a main switch and the like from an overload state that is short of an output short circuit.

An object of the present invention is providing a boost converter capable of suppressing an inrush current at startup. Another object of the present invention is providing a boosts converter capable of protecting its main switch and other components from an output short circuit or an overload when it occurs.

To attain the above object, the boost converter of the present invention includes: an input transistor to which an input voltage is applied; an inductor serially connected to the input transistor; a main switch serially connected to the inductor; rectifying means connected to a node between the inductor and the main switch; smoothing means for smoothing an output of the rectifying means to generate an output voltage; a current detection circuit for generating a current detection signal corresponding to a current flowing through the input transistor; a voltage detection circuit for generating a voltage detection signal corresponding to the output voltage; a startup circuit for adjusting the current flowing through the input transistor until the output voltage reaches a first voltage if the output voltage is lower than the first voltage, and turning ON the input transistor if the output voltage is higher than the first voltage; and a control circuit for controlling ON/OFF of the main switch based on the current detection signal and the voltage detection signal so that the output voltage becomes a predetermined value. With this configuration, in which the input transistor adjusts the input current from the input power supply at startup, occurrence of an inrush current can be prevented. Also, during normal operation, output voltage control and overload protection can be performed under the current mode control permitting high-speed response.

Specifically, the startup circuit may include: an auxiliary transistor having a current flow-in terminal and a control terminal common with the input transistor; a current source circuit connected to the common control terminal of the input transistor and the auxiliary transistor; a comparator for comparing the output voltage with the first voltage; and a switch circuit for short-circuiting the control terminal and a current flow-out terminal of the auxiliary transistor or short-circuiting the current source circuit based on an output of the comparator. With this configuration, the current flowing through the input transistor at startup can be made constant.

Preferably, the switch circuit has a time constant circuit for shifting the current source circuit from a short-circuited state to a non-short-circuited state with a predetermined time constant. With this configuration, an abrupt change in inductor current is suppressed, and thus no excessive counter electromotive force will occur in the inductor.

Specifically, the current detection circuit may include: an auxiliary transistor having an current flow-in terminal common with the input transistor, the auxiliary transistor being fixed to the ON state; and a feedback circuit for adjusting a current flowing through the auxiliary circuit so that a current flow-out terminal of the auxiliary circuit and a current flow-out terminal of the input transistor have an equal potential. With this configuration, the current at the input transistor can be detected with high precision.

Specifically, the control circuit may include: an averaging circuit for averaging a sum of a voltage generated based on the current detection signal and the voltage detection signal; and a PWM circuit for generating a drive signal for turning ON/OFF the main switch based on comparison between an output of the averaging circuit and a triangular wave signal. This permits adoption of the average current mode control permitting high-speed response to variations of the input/output conditions.

Alternatively, specifically, the control circuit may turn ON/OFF the main switch so that a voltage generated based on the current detection signal falls within a predetermined range. This permits adoption of the hysteresis current mode control permitting high-speed response to variations of the input/output conditions.

Alternatively, specifically, the control circuit may include: a clock generator for generating a one-shot pulse periodically; a comparator for comparing a voltage generated based on the current detection signal with the voltage detection signal; and a RS latch for turning ON/OFF the main switch, the RS latch being set with the one-shot pulse and reset with an output of the comparator. This permits adoption of the current mode control involving frequency-fixed peak value control permitting high-speed response to variations of the input/output conditions.

Specifically, the startup circuit may include: a current source forming circuit for adjusting the current flowing through the input transistor so that the current detection signal becomes a predetermined value; a comparator for comparing the output voltage with the first voltage; and a switch circuit for switching the current source forming circuit between being short-circuited and not being short-circuited based on an output of the comparator. With this configuration, the current flowing through the input transistor at startup can be made constant with high precision.

Preferably, the switch circuit has a time constant circuit for shifting the current source forming circuit from a short-circuited state to a non-short-circuited state with a predetermined time constant. With this configuration, an abrupt change in inductor current is suppressed, and thus no excessive counter electromotive force will occur in the inductor.

### BRIEF DESCRIPTION OF THE DRAWINGS

FIG. 1 is a circuit diagram of a boost converter of Embodiment 1 of the present invention.

FIG. 2 is a waveform diagram of various signals of the boost converter of Embodiment 1.

FIG. 3 shows an overload drooping characteristic of the boost converter of Embodiment 1.

FIG. 4 is a circuit diagram of a boost converter of Embodiment 2 of the present invention.

FIG. 5 is a circuit diagram of a boost converter of Embodiment 3 of the present invention.

FIG. 6 is a waveform diagram of various signals of the boost converter of Embodiment 3.

FIG. 7 is a circuit diagram of a boost converter of Embodiment 4 of the present invention.

FIG. 8 is a circuit diagram of a boost converter of Embodiment 5 of the present invention.

FIG. 9 is a circuit diagram of a conventional boost converter.

### DESCRIPTION OF THE PREFERRED EMBODIMENTS

Hereinafter, preferred embodiments of the present invention will be described with reference to the accompanying drawings.

### Embodiment 1

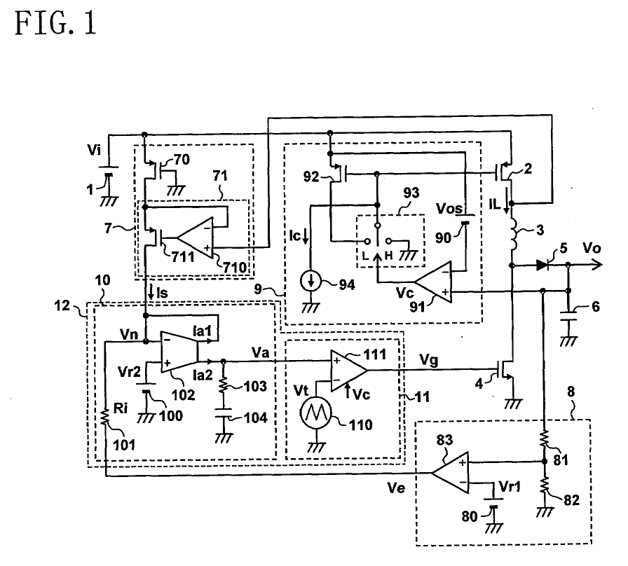

FIG. 1 is a circuit diagram of a boost converter of Embodiment 1. Referring to FIG. 1, an input power supply 1 such as a battery supplies a DC input voltage Vi. An input transistor 2 is a PMOS transistor whose source as the current flow-in terminal is connected to the input power supply 1. An inductor 3 has one terminal connected to the drain of the input transistor 2. A main switch 4 is made of an NMOS transistor whose drain is connected to the other terminal of the inductor 3 and whose source is grounded. A diode 5 as a rectifying means has an anode connected to the node between the main switch 4 and the inductor 3. An output capacitor 6 as a smoothing means is connected to the cathode of the diode 5 and outputs an output voltage Vo. Although not shown, the output voltage Vo is supplied as the power supply voltage for various electronic circuits that are to be load circuits.

A current detection circuit 7 includes: an auxiliary transistor 70 as a PMOS transistor whose source as the current flow-in terminal is connected to the input power supply 1 and whose gate as the control terminal is grounded; and a feedback circuit 71 for adjusting the current flowing through the auxiliary transistor 70 so that the current flow-out terminal of the auxiliary transistor 70 and the current flow-out terminal of the input transistor 2 are at an equal potential. Specifically, the feedback circuit 71 includes: an amplifier 710 receiving the voltage at the current flow-out terminal of the auxiliary transistor 70 and the voltage at the current flow-out terminal of the input transistor 2; and a PMOS transistor 711 whose source is connected to the drain of the auxiliary transistor 70 and whose gate receives the output of the amplifier 710. In other words, the amplifier 710 adjusts the source-drain impedance of the PMOS transistor 711 so that the drain voltage of the input transistor 2 and the drain voltage of the auxiliary transistor 70 are equal to each other. The drain current of the PMOS transistor 711 is outputted as a current detection signal Is. Note that the auxiliary transistor 70 and the input transistor 2 are placed close to each other on the same substrate.

A voltage detection circuit 8 includes: a reference voltage source 80 for outputting a reference voltage Vr1; resistances 81 and 82 for dividing the output voltage Vo; and an error amplifier 83 receiving the voltage at the node between these resistances and the reference voltage Vr1. The output voltage of the error amplifier 83 is outputted as a voltage detection signal Ve.

A startup circuit 9 includes: an offset voltage source 90 connected to the input power supply 1 at one terminal for generating an offset voltage Vos; a comparator 91 receiving the potential (Vi−Vos) at the other terminal of the offset voltage source 90 and the output voltage Vo; an auxiliary transistor 92 as a PMOS transistor whose source as the current flow-in terminal is connected to the input power source 1 and whose gate as the control terminal is connected to the gate as the control terminal of the input transistor 2; a switch circuit 93 for switching the connection of the gates of the input transistor 2 and the auxiliary transistor 92 between to the drain as the current flow-out terminal of the auxiliary transistor 92 and to a ground according to the output Vc of the comparator 91; and a current source circuit 94 connected to the gates of input transistor 2 and the auxiliary transistor 92.

An averaging circuit 10 and a PWM circuit 11 constitute a control circuit 12. The averaging circuit 10 includes: a reference voltage source 100 for outputting a reference voltage Vr2; a resistance 101 one terminal of which is connected to the output of the error amplifier 83 of the voltage detection circuit 8; a transconductance-type differential amplifier circuit (hereinafter, referred to as an OTA (operational transconductance amplifier)) 102 receiving the reference voltage Vr2 and the potential at the other terminal of the resistance 101 at its non-inverted and inverted input terminals, respectively, and having first and second outputs; a resistance 103 connected to the second output of the OTA 102; and a capacitor 104 connected in series with the resistance 103 at one terminal and grounded at the other terminal. The output currents from the first and second outputs of the OTA 102 are respectively referred to as Ia1 and Ia2. The inverted input terminal of the OTA 102 is also connected to the first output of the OTA 102 and the drain of the PMOS transistor 711 of the current detection circuit 7 to allow input of the current detection signal Is. The potential at the second output of the OTA 102 is outputted as an output voltage Va of the averaging circuit 10.

The PWM circuit 11 includes: a triangular wave generator 110 for outputting a triangular wave voltage Vt; and a PWM comparator 111 for comparing the output voltage Va of the averaging circuit 10 with the triangular wave voltage Vt. The output of the PWM comparator 111 is outputted as a drive signal Vg and applied to the gate of the main switch 4. The PWM comparator 111 is activated when the output Vc of the comparator 91 of the startup circuit 9 is at a high level (“H”), and inactivated when Vc is at a low level (“L”) making the output Vg “L”.

The operation of the boost converter of this embodiment configured as described above will be described. First, the operation at startup, at which the input power supply 1 is connected to the boost converter to generate the input voltage Vi, will be described.

In the startup circuit 9, the comparator 91 outputs “L” level as the output Vc because the output voltage Vo is lower than the potential (Vi−Vos) at the other terminal of the offset voltage source 90. The switch circuit 93 then connects the gates of the input transistor 2 and the auxiliary transistor 92 to the drain of the auxiliary transistor 92. Also, with the current source circuit 94 allowing flow of a constant current Ic, the input transistor 2, the auxiliary transistor 92 and the current source circuit 94 constitute a current mirror circuit. Assuming that the mirror ratio (size ratio) of the input transistor 2 to the auxiliary transistor 92 is n:1, the current IL flowing through the input transistor 2 will be a roughly constant current as expressed by:

IL=n·Ic (1)

In the PWM circuit 11, when the output Vc of the comparator 91 of the startup circuit 9 is “L”, the drive signal Vg outputted from the PWM comparator 111 is also “L”, and thus the main switch 4 is OFF. Hence, in the boost converter of this embodiment, no inrush current will occur at startup.

It is only when the output voltage Vo reaches the voltage Vi−Vos that the constant-current operation described above terminates, turning ON the input transistor 2 and switches to the switching boost control operation with the current detection circuit 7, the voltage detection circuit 8 and the control circuit 12 (this operation will be described later). Hence, the offset voltage Vos is desirably set, considering the ON-time voltage drops of the inductor 3 and the diode 5, at a voltage slightly larger than the sum of these voltage drops.

The charging of the output capacitor 6 proceeds with the constant-voltage operation of the input transistor 2 via the inductor 3 and the diode 5. Once the output voltage Vo exceeds the voltage Vi−Vos, the output Vc of the comparator 91 is inverted to “H” level. The switch circuit 93 then grounds the gates of the input transistor 2 and the auxiliary transistor 92, and this fixes the input transistor 2 to the ON state. Simultaneously, the current source circuit 94 is short-circuited to a ground and inactivated.

In the current detection circuit 7, the amplifier 710 controls the source-drain impedance of the PMOS transistor 711 so that the voltage of the drain as the current flow-out terminal of the auxiliary transistor 70, which is fixed to the ON state like the input transistor 2, is equal to the voltage of the drain as the current flow-out terminal of the input transistor 2. In other words, the current flowing from the auxiliary transistor 70 through the PMOS transistor 711, i.e., the current detection signal Is, is adjusted so that the drain voltages of the auxiliary transistor 70 and the input transistor 2 are equal to each other. As a result, the current detection signal Is becomes proportional to the drain current of the input transistor 2 with high precision. Assuming that the mirror ratio (size ratio) of the input transistor 2 to the auxiliary transistor 70 is m:1, the current detection signal Is is expressed by:

Is=IL/m (2)

In the voltage detection circuit 8, the output voltage Vo is divided with the resistances 81 and 82, the divided voltage is compared with the reference voltage Vr1 and amplified, and the resultant error voltage is outputted as the voltage detection signal Ve. The voltage detection signal Ve rises when the divided voltage is higher than the reference voltage Vr1, and drops when it is lower than the reference voltage Vr1. At startup, the divided voltage is lower than the reference voltage Vr1. The voltage detection signal Ve is therefore at a low potential level.

In the averaging circuit 10, the current detection signal Is and the first output current Ia1 of the OTA 102 flow into the resistance 101 that receives the voltage detection signal Ve at one terminal. The voltage Vn at the inverted-input terminal of the OTA 102 is expressed by:

Vn=Ve+(Is+Ia1)·Ri

where Ri is the resistance value of the resistance 101. Also, the first output current Ia1 is expressed by:

Ia1=Gm1·(Vr2−Vn)

where Gm1 is the mutual conductance for generating the first output current Ia1 of the OTA 102. Combining the above equations deleting Ia1, Vn is expressed by:

Vn=(Ve+Is·Ri+Gm1·Vr2·Ri)/(1+Gm1·Ri)

Hence, the second output current Ia2 is expressed by:

$$\begin{matrix}Ia 2 = Gm 2 \cdot ( Vr 2 - Vn ) \\ = Gm 2 \cdot ( Vr 2 - Ve - Is \cdot Ri ) / ( 1 + Gm 1 \cdot Ri )\end{matrix} \qquad ( 3 )$$

The current Ia2 flows through the series circuit of the resistance 103 and the capacitor 104, to give the second output Va. At startup, at which the voltage detection signal Ve is at the low potential level and the current IL flowing through the input transistor 2 is not so large after the constant-current flow, the second output current Ia2 is positive and thus the second output Va rises.

In the PWM circuit 11, the PWM comparator 111, activated with the output Vc of the comparator 91 of the startup circuit 9 becoming “H”, compares the output Va of the averaging circuit 10 with the triangular wave voltage Vt and outputs the drive pulse signal Vg, with which ON/OFF control of the main switch 4 is started. The pulse width of the “H” level of the drive pulse signal Vg, that is, the ON time of the main switch 4 increases as the output Va rises.

When the main switch 4 is ON, the input voltage Vi is applied to the inductor 3, and with increase of the flowing current, electromagnetic energy is increasingly stored in the inductor 3. This energy is released from the inductor 3 through the diode 5 as the current charging the output capacitor 6 when the main switch 4 is OFF. With repetition of this ON/OFF of the main switch 4, the charging of the output capacitor 6 proceeds raising the output voltage Vo.

The ON time of the main switch 4 increases with rise of the output Va of the averaging circuit 10 as described above. This increase of the ON time and the accompanying increase of the current IL are however restricted for the following reason.

In the voltage detection circuit 8, the general lower-limit value of the voltage detection signal Ve is 0 V. In this case, in equation (3), if the current detection signal Is exceeds Vr2/Ri, the second output current Ia2 becomes a negative value. This discharges the capacitor 104 and thus drops the output Va of the averaging circuit 10. In the PWM circuit 11, therefore, the pulse width of the drive signal Vg, that is, the ON time of the main switch 4 is shortened. Hence, the upper-limit value ILmax of the current IL is expressed by:

ILmax=m·Vr2/Ri

Although not shown in FIG. 1, it is found from the above operation that the upper-limit value ILmax of the current IL can be adjusted as follows by setting a lower-limit value Vemin for the voltage detection signal Ve.

ILmax=m·(Vr2−Vemin)/Ri (4)

Next, the operation in which the divided voltage with the resistances 81 and 82 is stably equal to the reference voltage Vr1 in the voltage detection circuit 8 will be described. The output voltage Vo is expressed by:

Vo=(1+R1/R2)·Vr1 (5)

where R1 and R2 are respectively the resistance values of the resistances 81 and 82.

In the stable operation state, the pulse width of the drive signal Vg outputted from the PWM comparator 111 is stable. In a boost converter like that of this embodiment, the relationship between the proportion 6 of the pulse width, that is, the ON time of the main switch 4 in one switching period (called the duty ratio) and the input/output voltages is expressed by:

Vo=Vi/(1−δ) (6)

To allow the pulse width of the drive signal Vg to be stable as described above, the output Va of the averaging circuit 10 must be stable in the DC level, and for this reason, the DC levels of the first and second output currents Ia1 and Ia2 are both 0 A. Also, since both the voltage detection signal Ve and the output Va of the averaging circuit 10 are stable in the DC level, the voltage detection signal Ve and the current detection signal Is in the DC level have the relationship of

Vr2=Ve+Is·Ri

derived from equation (3). Moreover, using equation (2), the current IL flowing through the input transistor 2 and the inductor 3 is expressed in the DC level or the average level by:

IL(ave)=m·(Vr2−Ve)/Ri (7)

Having such a linear relationship between the average of the inductor current IL and the voltage detection signal Ve, the control scheme in this embodiment is called as an average current mode control scheme.

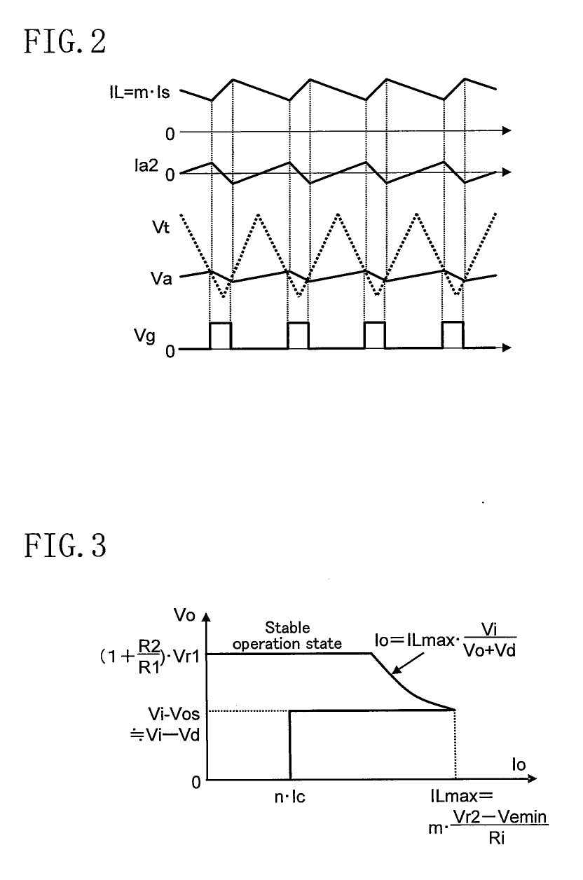

FIG. 2 is a waveform diagram of various signals of the boost converter of this embodiment. The inductor current IL is a triangular current increasing/decreasing according to the ON/OFF operation of the main switch 4. The current detection signal Is, which is proportional to the current IL, flows into the resistance 101 and a voltage generated at the resistance 101 is applied to one of the input terminals of the OTA 102.

Hence, the second output current Ia2 of the OTA 102 and the output voltage Va have waveforms like ones inverted from the inductor current IL. Note however that in the stable operation state, the DC level of the second output current Ia2 of the OTA 102 is 0 A, and the DC level of the output voltage Va is stable, as described above.

In the above stable operation state, if the output voltage Vo drops for reasons such as that the current consumption of a load circuit not shown increases and that the input voltage Vi drops, the following feedback is exerted to stabilize the output voltage Vo to satisfy equation (5).

1) Since the divided voltage with the resistances 81 and 82 goes lower than the reference voltage Vr1, the voltage detection signal Ve outputted from the error amplifier 83 drops.

2) With the drop of the voltage detection signal Ve, the inverted input voltage Vn of the OTA 102 drops, and this increases the second output current Ia2.

3) With the increase of the second output current Ia2, the capacitor 104 is charged raising the output Va of the averaging circuit 10.

4) With the rise of the output Va of the averaging circuit 10, the pulse width of the drive signal Vg outputted from the PWM circuit 11, that is, the ON time of the main switch 4 becomes long.

5) With the long ON time of the main switch 4 and accompanying increase of the duty ratio 6, the inductor current IL increases, and this raises the output voltage Vo.

Next, the overload protection operation of the boost converter of this embodiment will be described. When the current consumption of a load circuit not shown becomes excessive in the stable operation state, the feedback described above is exerted to increase the inductor current IL. However, if the voltage detection signal Ve reaches its lower-limit value and no more drop is permitted, the above feedback is no more exerted. In other words, the increasing inductor current IL reaches the upper-limit value of equation (4). Once this happens, the second output current Ia2 becomes a negative value, dropping the output Va of the averaging circuit 10. In the PWM circuit 11, the pulse width of the drive signal Vg, that is, the ON time of the main switch 4 is shortened. Hence, the output voltage Vo drops failing to maintain the stabilization target value of equation (5). During this overload operation, the inductor current IL is made to maintain the upper-limit value of equation (4). The output current Io from the output capacitor 6 is therefore expressed by:

Io=ILmax·Vi/(Vo+Vd) (8)

where Vd is a forward voltage drop of the diode 5.

The drooping characteristic obtained from equation (8) is shown in FIG. 3, which also includes the state during the stable operation. Once the output voltage Vo goes below the voltage Vi−Vos according to the status of the overload, the output of the comparator 91 of the startup circuit 9 is inverted to “L” level allowing the input transistor 2 to operate as the constant-current source. This also applies to the case of an output short circuit. As already described, the offset voltage Vos of the voltage Vi−Vos is set at a value slightly larger than the ON-time voltage drops of the inductor 3 and the diode 5. In other words, since Vi−Vos≈Vi−Vd, Io≈ILmax is satisfied under the condition of Vo=Vi−Vos.

As described above, in this embodiment, by detecting the current flowing through the input transistor 2, the current mode control of controlling the output voltage Vo under adjustment of the inductor current IL can be adopted during normal operation. Also, since an upper-limit value can be set for the inductor current IL, the output drooping characteristic is exhibited. Moreover, with the input transistor 2 operating as a constant-current source, overload protection and output short-circuit protection can be provided.

### Embodiment 2

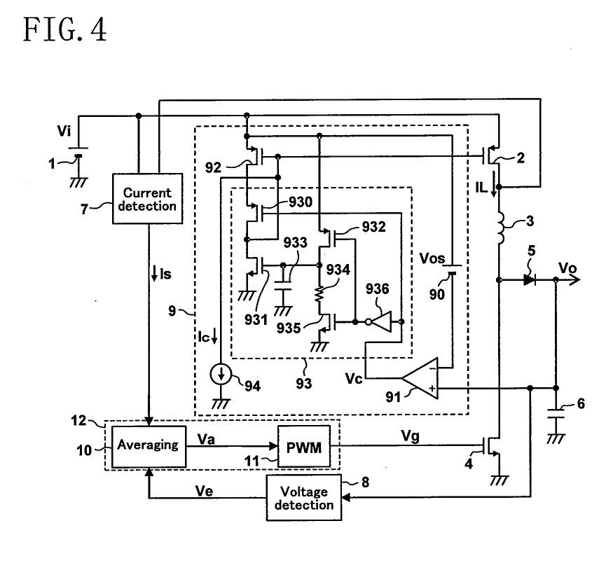

FIG. 4 is a circuit diagram of a boost converter of Embodiment 2. The boost converter of this embodiment is adapted to prevent generation of a counter electromotive force in an inductor, which may occur due to an abrupt current change when the input transistor shifts to the constant-current operation at the occurrence of an output short circuit and the like. Hereinafter, only the point different from the boost converter of Embodiment 1 will be described.

The switch circuit 93 includes: a PMOS transistor 930 for connecting the gates of the input transistor 2 and the auxiliary transistor 92 with the drain of the auxiliary transistor 92; an NMOS transistor 931 for grounding the gates of the input transistor 2 and the auxiliary transistor 92; a PMOS transistor 932 for applying the input voltage Vi to the gate of the NMOS transistor 931; a capacitor 933 connected between the gate and source of the NMOS transistor 931; a resistance 934 and an NMOS transistor 935 serially connected between the gate and source of the NMOS transistor 931; and an inverter 936 the output of which is connected to the gates of the PMOS transistor 932 and the NMOS transistor 935. The output Vc of the comparator 91 is applied to the gate of the PMOS transistor 930 and the input of the inverter 936. The capacitor 933 and the resistance 934 constitute a time constant circuit utilizing the CR time constant. The time constant circuit is not limited to this configuration.

The operation of the boost converter of this embodiment configured as described above will be described. First, the operation at startup, at which the input power supply 1 is connected to the boost converter to generate the input voltage Vi, will be described.

In the startup circuit 9, the comparator 91 outputs “L” level as the output Vc because the output voltage Vo at startup is lower than the potential (Vi−Vos) at the other terminal of the offset voltage source 90. In the switch circuit 93, therefore, the PMOS transistor 930 is ON, connecting the gates of the input transistor 2 and the auxiliary transistor 92 with the drain of the auxiliary transistor 92. Also, because the current source circuit 94 allows flow of the constant current Ic, the input transistor 2, the auxiliary transistor 92 and the current source circuit 94 constitute a current mirror circuit. The current IL flowing through the input transistor 2 is therefore roughly constant. At this time, an “H” level voltage is applied to the gates of the PMOS transistor 932 and the NMOS transistor 935 via the inverter 936, turning OFF the PMOS transistor 932 and ON the NMOS transistor 935, and thus the NMOS transistor 931 is OFF. Hence, in the boost converter of this embodiment, no inrush current will occur at startup.

The charging of the output capacitor 6 proceeds with the constant-current operation of the input transistor 2 via the inductor 3 and the diode 5. Once the output voltage Vo exceeds the voltage Vi−Vos, the output Vc of the comparator 91 is inverted to “H” level.

In response to this, in the switch circuit 93, the PMOS transistor 930 is turned OFF, putting the drain of the auxiliary circuit 92 in high impedance. Simultaneously, the PMOS transistor 932 is turned ON and the NMOS transistor 935 is turned OFF. The capacitor 933 is therefore charged swiftly, turning ON the NMOS transistor 931. Hence, the gates of the input transistor 2 and the auxiliary transistor 92 are grounded fixing the input transistor 2 to the ON state, and the current source circuit 94 is short-circuited to a ground and inactivated. Thereafter, the main switch 4 is ON/OFF-controlled with the drive signal Vg from the PWM circuit 11, allowing the boost converter to shift to the switching control operation. This operation is as described above in Embodiment 1.

Next, the protection operation performed from the state where the inductor current IL has increased due to an abrupt overload, an output short circuit and the like will be described. As in Embodiment 1, the output voltage droops at the occurrence of an overload in the boost converter of this embodiment. Once the output voltage Vo goes below the voltage Vi−Vos, the output Vc of the comparator 91 of the startup circuit 9 is inverted to “L” level. At this time, the PMOS transistor 930 is turned ON swiftly. Also, with the output of the inverter 936 being inverted to “H” level, the PMOS transistor 932 is turned OFF while the NMOS transistor 935 is turned ON. Meanwhile, since the voltage of the capacitor 933, which is the gate potential of the NMOS transistor 931, is discharged via the resistance 934, the NMOS transistor 931 is not turned OFF swiftly, but shifts to the OFF state slowly. Hence, with the gate of the input transistor 2 gradually rising from the grounded state according to the CR time constant of the capacitor 933 and the resistance 934, the input transistor 2 also gradually shifts to the constant-current operation expressed by equation (1).

As described above, in this embodiment, even when the output voltage Vo is below the voltage Vi−Vos at the occurrence of an output short circuit and the like, the input transistor 2 slowly shifts to the constant-current operation. Hence, with an abrupt change in inductor current IL being suppressed, no excessive counter electromotive force will be generated in the inductor 3.

### Embodiment 3

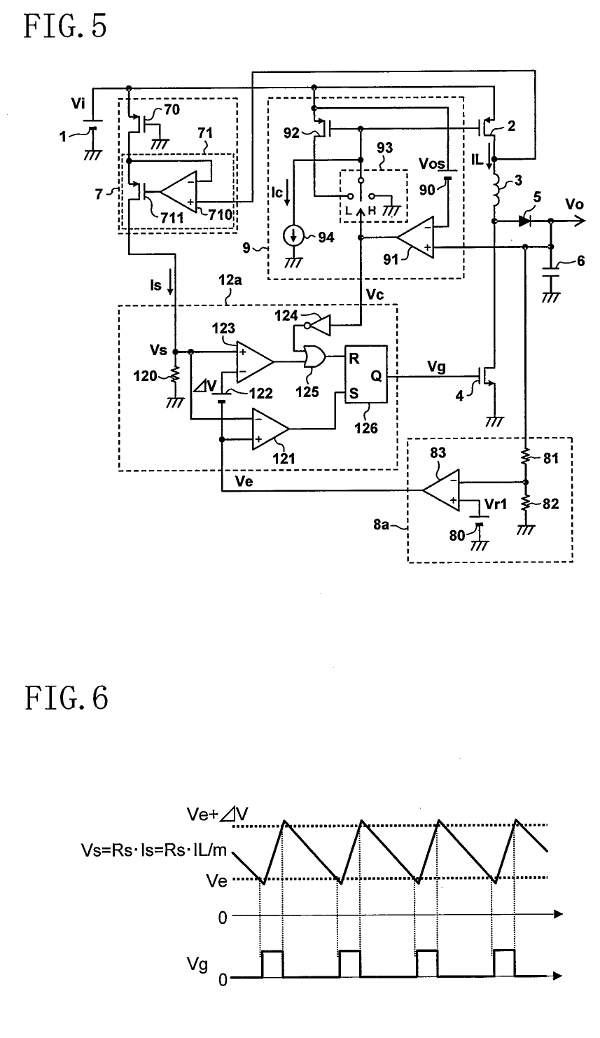

FIG. 5 is a circuit diagram of a boost converter of Embodiment 3. The boost converter of this embodiment adopts a hysteresis current mode. Hereinafter, only the point different from the boost converter of Embodiment 1 will be described.

In a voltage detection circuit 8a, the voltage obtained by dividing the output voltage Vo with the resistances 81 and 82 is inputted into the inverted input terminal of the error amplifier 83, and the reference voltage Vr1 is inputted into the non-inverted input terminal thereof. A control circuit 12a includes: a resistance 120 (resistance value: Rs) for converting the current detection signal Is from the current detection circuit 7 to a voltage Vs; a first comparator 121 for comparing the voltage Vs with the voltage detection signal Ve from the voltage detection section 8a; an offset voltage source 122 for superimposing an offset voltage ΔV on the voltage detection signal Ve; a second comparator 123 for comparing the voltage Vs with the voltage Ve+ΔV; an inverter 124 receiving the comparison output Vc from the startup circuit 9; an OR gate 125 receiving the outputs of the second comparator 123 and the inverter 124; and a reset-dominant RS latch 126 that is set with the output of the first comparator 121, is reset with the output of the OR gate 125 and outputs the drive signal Vg via its Q output.

As in Embodiment 1, at startup at which the output voltage Vo is low, the input transistor 2 performs the constant-current operation when the output Vc of the comparator 91 is “L”. In the control circuit 12a, the RS latch 126, receiving Vc via the inverter 124 and the OR gate 125 at its reset input, outputs the “L” level drive signal Vg. The main switch 4 is therefore kept in the OFF state. Once the output voltage Vo exceeds the voltage Vi−Vos under the constant-current operation of the input transistor 2, the input transistor 2 is fixed to the ON state, and the current source circuit 94 is short-circuited to a ground and inactivated. In this embodiment, unlike Embodiment 1, the voltage detection signal Ve from the voltage detection circuit 8a drops when the divided voltage is higher than the reference voltage Vr1 and rises when it is lower than the reference voltage Vr1. At startup, the divided voltage is lower than the reference voltage Vr1, and thus the voltage detection signal Ve is at the high-potential level.

Once the voltage Vc goes “H”, the RS latch 126 of the control circuit 12a is released from the reset-fixed state. The voltage detection signal Ve at the high-potential level makes the output of the comparator 121 “H” and the output of the comparator 123 “L”. The RS latch 126 is therefore set turning the drive signal Vg to “H” level. This turns ON the main switch 4, and the inductor current IL increases.

The inductor current IL flowing through the input transistor 2 is detected with the current detection circuit 7 and converted to the voltage Vs with the resistance 120. Once the voltage Vs rises exceeding the voltage detection signal Ve, the output of the comparator 121 goes “L”. When the voltage Vs further rises exceeding the voltage Ve+ΔV, the output of the comparator 123 goes “H”. This resets the RS latch 126 to make the drive signal Vg “L”. This turns OFF the main switch 4, and the inductor current IL gradually decreases while charging the output capacitor 6.

Along with the decrease of the inductor current IL, the voltage Vs drops. Once the voltage Vs becomes below the voltage Ve+ΔV, the output of the comparator 123 goes “L”. When the voltage Vs further drops below the voltage detection signal Ve, the output of the comparator 121 goes “H”. This sets the RS latch 126 to make the drive signal Vg “H”. With this repetition of ON/OFF of the main switch 4, charging of the output capacitor 6 proceeds, raising the output voltage Vo.

Although not shown in FIG. 5, it is found from the above operation that the upper-limit value ILmax of the current IL can be adjusted as expressed below by setting an upper-limit value Vemax for the voltage detection signal Ve.

ILmax=m·Vemax/Rs (9)

Next, the operation in which the divided voltage with the resistances 81 and 82 is stably equal to the reference voltage Vr1 in the voltage detection circuit 8a will be described. FIG. 6 is a waveform diagram of various signals observed when the boost converter of this embodiment is in the stable operation state. Note that the output voltage Vo is expressed by equations (5) and (6). To make the pulse width of the drive signal Vg stable, the DC level of the voltage detection signal Ve must be stable. The peak value ILp and valley value ILv of the current IL flowing through the input transistor 2 and the inductor 3 are expressed as follows:

From peak value of Vs=Rs·ILp/m=Ve+ΔV,

ILp=m·(Ve+ΔV)/Rs (10)

From valley value of Vs=Rs·ILv/m=Ve,

ILv=m·Ve/Rs (11)

As described above, the level and variation width of the inductor current IL is set with the voltage detection signal Ve and the offset voltage ΔV. The control scheme in this embodiment is therefore called a hysteresis current mode control scheme.

In the above stable operation state, if the output voltage Vo drops due to reasons such as that the current consumption of a load circuit not shown increases and that the input voltage Vi drops, the following feedback is exerted to stabilize the output voltage Vo to satisfy equation (5).

1) The divided voltage with the resistances 81 and 82 goes lower than the reference voltage Vr1, and this raises the voltage detection signal Ve outputted from the error amplifier 83;

2) With the rise of the voltage detection signal Ve, the time required for the voltage Vs to reach the voltage Ve+ΔV, that is, the ON time of the main switch 4 becomes long; and

3) With the long ON time of the main switch 4 and accompanying increase of the duty ratio 6, the inductor current IL increases, and this raises the output voltage Vo.

The overload protection operation of the boost converter of this embodiment, in which an upper-limit value is virtually set for the inductor current IL by setting an upper-limit value for the voltage detection signal Ve, exhibits the drooping characteristic according to equation (8) as in Embodiment 1.

As described above, in this embodiment, by detecting the current flowing through the input transistor 2, the current mode control can be adopted during normal operation, in which the output voltage Vo is controlled under adjustment of the inductor current IL. Also, since an upper-limit value can be set for the inductor current IL, the output drooping characteristic is exhibited. Moreover, overload protection and output short-circuit protection can be provided with the input transistor 2 operating as a constant-current source when the output voltage is at the low level.

### Embodiment 4

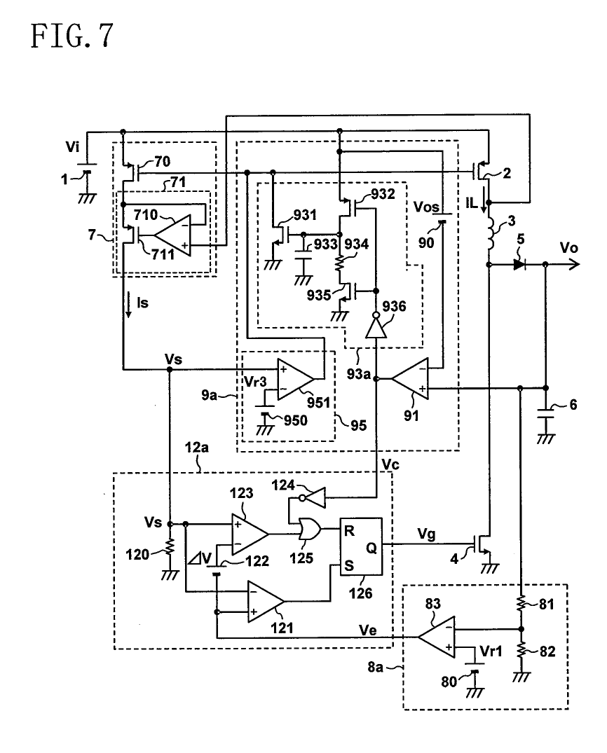

FIG. 7 is a circuit diagram of a boost converter of Embodiment 4. The boost converter of this embodiment is a partial alteration of the boost converter of Embodiment 3. Hereinafter, only the point different from the boost converter of Embodiment 3 will be described.

In a startup circuit 9a, a switch circuit 93a includes: an NMOS transistor 931 provided to ground the gate of the input transistor 2; a PMOS transistor 932 for applying the input voltage Vi to the gate of the NMOS transistor 931; a capacitor 933 connected between the gate and source of the NMOS transistor 931; a resistance 934 and an NMOS transistor 935 serially connected between the gate and source of the NMOS transistor 931; and an inverter 936 connected to the gates of the PMOS transistor 932 and the NMOS transistor 935. The output Vc of the comparator 91 is applied to the inverter 936. A current source forming circuit 95 includes: a voltage source circuit 950 for generating a reference voltage Vr3; and an amplifier 951 receiving the voltage Vs generated in the control circuit 12a and the reference voltage Vr3. The output of the amplifier 951 is connected to the gate as the control terminal of the input transistor 2.

Hereinafter, the operation of the boost converter of this embodiment at startup, at which the input power supply 1 is connected to the boost converter to generate the input voltage Vi, will be described.

In the startup circuit 9a, the output Vc of the comparator 91 is “L” because the output voltage Vo at startup is lower than the potential (Vi−Vos) at the other terminal of the offset voltage source 90. In the switch circuit 93a, therefore, an “H” level voltage is applied to the gates of the PMOS transistor 932 and the NMOS transistor 935 via the inverter 936, turning OFF the PMOS transistor 932 and ON the NMOS transistor 935, and thus the NMOS transistor 931 is OFF. Meanwhile, the inductor current IL flowing through the input transistor 2 is detected with the current detection circuit 7, and the voltage Vs corresponding to the inductor current IL is generated in the control circuit 12a. The amplifier 951 of the current source forming circuit 95 adjusts the gate voltage of the input transistor 2 so that the voltage Vs is equal to the reference voltage Vr3. In other words, the inductor current IL flowing through the input transistor 2 is made constant as expressed by:

IL=m·Vr3/Rs (12)

Hence, since the current flowing through the input transistor 2 is made constant at startup, no inrush current will occur in the boost converter of this embodiment.

Under the constant-current operation of the input transistor 2, once the output voltage Vo exceeds the voltage Vi−Vos, the output Vc of the comparator 91 is inverted to “H” level. In response to this, in the switch circuit 93a, the PMOS transistor 932 is turned ON while the NMOS transistor 935 is turned OFF. The capacitor 933 is therefore charged swiftly turning ON the NMOS transistor 931. Hence, the gate of the input transistor 2 is grounded fixing the input transistor 2 to the ON state, and the current source forming circuit 95 is short-circuited to a ground and inactivated.

Thereafter, as in Embodiment 3, the main switch 4 is ON/OFF-controlled with the drive signal Vg from the control circuit 12a, causing the boost converter to shift to the switching control operation. The protection operation to be performed when the inductor current IL becomes large due to an abrupt overload, an output short-circuit and the like is as described above in Embodiment 2.

When the output of the inverter 936 becomes “H”, the PMOS transistor 932 is turned OFF while the NMOS transistor 935 is turned ON. The voltage of the capacitor 933 is therefore discharged via the resistance 934, and the NMOS transistor 931 gradually shifts to the OFF state. Hence, with the gate of the input transistor 2 gradually rising from the grounded state, the input transistor 2 also gradually shifts to the constant-current operation. This suppresses an abrupt change in inductor current IL, and thus no excessive counter electromotive force will occur in the inductor 3.

As described above, in this embodiment, the auxiliary transistor 70 of the current detection circuit 7 plays the role of the auxiliary transistor 92 in the boost converters of Embodiments 1 to 3, and the voltage Vs in the control circuit 12a at startup is fed back so as to be equal to the reference voltage Vr3. Hence, the inductor current IL flowing through the input transistor 2 is made constant.

### Embodiment 5

As described in the above embodiments, the boost converter according to the present invention is suited to both the average current mode control scheme and the hysteresis current mode control scheme. Other examples of current mode control schemes using the inductor current for output control include: controlling the inductor current peak or valley value while fixing the switching frequency; controlling the inductor current peak value while fixing the OFF time of the main switch; and controlling the inductor current valley value while fixing the ON time of the main switch. The present invention is applicable to any of these control schemes.

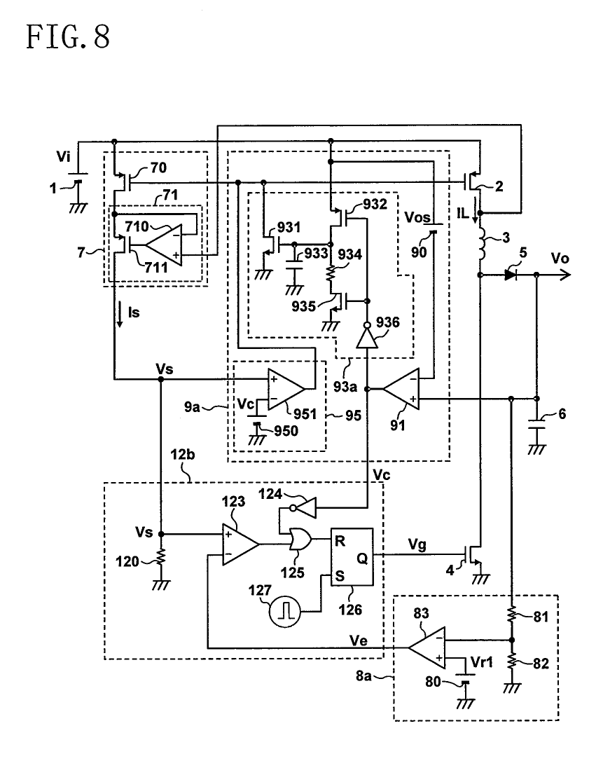

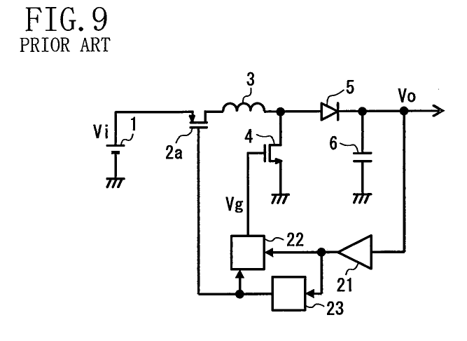

FIG. 8 is a circuit diagram of a boost converter of Embodiment 5. The boost converter of this embodiment adopts the scheme of controlling the inductor current peak value while fixing the switching frequency. Hereinafter, only the point different from the boost converter of Embodiment 4 will be described.

When the drive signal Vg as the output of the RS switch 126 of a control circuit 12b is “H”, the main switch 4 is ON increasing the inductor current IL. With the increase of the inductor current IL, the current detection signal Is from the current detection circuit 7 also increases. Hence, the voltage Vs converted from Is with the resistance 120 rises. Once the voltage Vs exceeds the voltage detection signal Ve, the output of the comparator 123 is inverted to “H” level, which resets the RS latch 126 via the OR gate 125. With this, the drive signal Vg as the output of the RS latch 126 is inverted to “L” level turning OFF the main switch 4. With the main switch 4 being OFF, the inductor current IL flows through the diode 5 to charge the output capacitor 6. During this time when the main switch 4 is OFF, the inductor current IL decreases with release of electromagnetic energy of the inductor 3. The voltage Vs therefore starts to drop and this makes the output of the comparator 123 “L”. Meanwhile, a clock generator 127 generates one-shot pulse periodically. With this one-shot pulse, the RS latch 126 is set changing the drive signal Vg to “H” level and thus turning ON the main switch 4.

With repetition of the ON/OFF operation of the main switch 4, the boost converter supplies power from the output capacitor 6 to a load circuit not shown. To allow the pulse width of the drive signal Vg to be stable, the DC level of the voltage detection signal Ve must be stable. The peak value ILp of the current IL flowing through the input transistor 2 and the inductor 3 is expressed as follows.

From peak value of Vs=Rs·ILp/m=Ve,

ILp=m·Ve/Rs (13)

As described above, the peak value of the inductor current IL is set with the voltage detection signal Ve, and the switching frequency is fixed to the frequency of the clock generator 127. The control scheme in this embodiment is therefore called a current mode control scheme involving frequency-fixed peak value control.

In the above stable operation state, if the output voltage Vo drops for the reasons such as that the current consumption of a load circuit not shown increases and that the input voltage Vi drops, the following feedback is exerted to stabilize the output voltage Vo to satisfy equation (5).

1) The divided voltage with the resistances 81 and 82 goes lower than the reference voltage Vr1, and this raises the voltage detection signal Ve outputted from the error amplifier 83;

2) With the rise of the voltage detection signal Ve, the time required for the voltage Vs to reach the voltage detection signal Ve, that is, the ON time of the main switch 4 becomes long; and

3) With the long ON time of the main switch 4 and accompanying increase of the duty ratio 6, the inductor current IL increases, and this raises the output voltage Vo.

While the present invention has been described in preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

What is claimed is:

1. A boost converter comprising:
an input transistor to which an input voltage is applied;
an inductor serially connected to the input transistor;
a main switch serially connected to the inductor;
rectifying means connected to a node between the inductor and the main switch;
smoothing means for smoothing an output of the rectifying means to generate an output voltage;
a current detection circuit for generating a current detection signal corresponding to a current flowing through the input transistor;
a voltage detection circuit for generating a voltage detection signal corresponding to the output voltage;
a startup circuit for adjusting the current flowing through the input transistor until the output voltage reaches a first voltage if the output voltage is lower than the first voltage, and turning ON the input transistor if the output voltage is higher than the first voltage; and
a control circuit for controlling ON/OFF of the main switch based on the current detection signal and the voltage detection signal so that the output voltage becomes a predetermined value.

2. The boost converter of claim 1, wherein the startup circuit comprises:
an auxiliary transistor having a current flow-in terminal and a control terminal common with the input transistor;
a current source circuit connected to the common control terminal of the input transistor and the auxiliary transistor;
a comparator for comparing the output voltage with the first voltage; and
a switch circuit for short-circuiting the control terminal and a current flow-out terminal of the auxiliary transistor or short-circuiting the current source circuit based on an output of the comparator.

3. The boost converter of claim 2, wherein the switch circuit has a time constant circuit for shifting the current source circuit from a short-circuited state to a non-short-circuited state with a predetermined time constant.

4. The boost converter of claim 1, wherein the current detection circuit comprises:
an auxiliary transistor having an current flow-in terminal common with the input transistor, the auxiliary transistor being fixed to the ON state; and
a feedback circuit for adjusting a current flowing through the auxiliary circuit so that a current flow-out terminal of the auxiliary circuit and a current flow-out terminal of the input transistor have an equal potential.

5. The boost converter of claim 4, wherein the control circuit comprises:
an averaging circuit for averaging a sum of a voltage generated based on the current detection signal and the voltage detection signal; and
a PWM circuit for generating a drive signal for turning ON/OFF the main switch based on comparison between an output of the averaging circuit and a triangular wave signal.

6. The boost converter of claim 4, wherein the control circuit turns ON/OFF the main switch so that a voltage generated based on the current detection signal falls within a predetermined range.

7. The boost converter of claim 4, wherein the control circuit comprises:
a clock generator for generating a one-shot pulse periodically;
a comparator for comparing a voltage generated based on the current detection signal with the voltage detection signal; and
a RS latch for turning ON/OFF the main switch, the RS latch being set with the one-shot pulse and reset with an output of the comparator.

8. The boost converter of claim 1, wherein the startup circuit comprises:
a current source forming circuit for adjusting the current flowing through the input transistor so that the current detection signal becomes a predetermined value;
a comparator for comparing the output voltage with the first voltage; and
a switch circuit for switching the current source forming circuit between being short-circuited and not being short-circuited based on an output of the comparator.

9. The boost converter of claim 8, wherein the switch circuit has a time constant circuit for shifting the current source forming circuit from a short-circuited state to a non-short-circuited state with a predetermined time constant.
